(19) United States
(12) Patent Application Publication
(10) Pub. No.: US 2018/0111652 A1
(43) Pub. Date: Apr. 26, 2018

(54) ELECTRIC BICYCLE BATTERY ANTI-THEFT DEVICE AND METHOD

(71) Applicant: ONIL SYSTEMS LTD, Tel-Aviv (IL)

(72) Inventor: Gal HALEVI, Kiryat Ono (IL)

(73) Assignee: ONIL SYSTEMS LTD, Tel-Aviv (IL)

(21) Appl. No.: 15/793,039

(22) Filed: Oct. 25, 2017

Related U.S. Application Data
(60) Provisional application No. 62/412,296, filed on Oct. 25, 2016.

(51) Int. Cl. B62H 5/00; B62M 6/90; B62K 19/30; E05B 71/00

(52) U.S. Cl. CPC B62H 5/001; B62M 6/90; B60L 2200/12; E05B 71/00; B62K 19/30

(57) ABSTRACT

An anti-theft device for battery of electric bicycle is described. The device locks the battery to the frame of electric bicycle. The device preferably further locks the rear wheel of the electric bicycle.

### CROSS REFERENCE TO RELATED APPLICATIONS

This application claims priority and herein incorporates by reference U.S. provisional patent application 62/412,296, filed Oct. 25, 2016.

### TECHNICAL FIELD

The present invention relates to electric bicycles. More particularly, the present invention relates to anti-theft devices for electric bicycles.

### BACKGROUND OF THE INVENTION

Electric bicycles are vulnerable, inter alia, to theft as a whole, theft of at least one wheel, and theft of the battery supplying the power for operating the electric bicycle. The currently available anti-theft solutions provide separate protection for each component of the electric bicycle that is vulnerable to theft—a lock that specifically locks a wheel, a lock that specifically locks the electric bicycle's frame, and a lock that specifically locks the battery.

Options to lock the battery together with the frame, and options to lock a wheel and the frame are also available. Thus, multiple locks are required to protect these components all together against theft. Furthermore, some of the solutions currently available for protecting the battery are easily breakable and not robust in the sense of protecting the battery against theft. An alternative solution is that a user may uninstall the battery, and/or at least one of the wheels, in order to prevent their theft, while for example locking the frame of the electric bicycle to a fixed object.

### SUMMARY OF THE INVENTION

The invention was made in view of the deficiencies of the prior art and provides devices and methods processes for overcoming these deficiencies. According to some embodiments and aspects of the present invention, there is provided a device and method pertaining to electric bicycles in which a battery is inserted in a gap defined by a seat tube and a rail close to a rear wheel of the electric bicycle, according to various embodiments.

One aim of the present invention is to provide a combined battery anti-theft device for an electric bicycle in which a battery is inserted in a gap defined by a seat tube and a rail close to a rear wheel of the electric bicycle.

Another aim of the present invention is to provide a combined battery anti-theft device that is robust and not easily breakable.

Yet another aim of the present invention is to provide a device that is configured to lock with a single bicycle lock a battery, a wheel and a frame of an electric bicycle in which a battery is inserted in a gap defined by a seat tube and a rail close to a rear wheel of the electric bicycle.

The present invention provides a combined battery anti-theft device for an electric bicycle in which a battery is inserted in a gap defined by a seat tube and a rail close to a rear wheel of the electric bicycle. For the sake of simplicity only, the combined battery anti-theft device is occasionally referred to hereinafter as the “device”.

According to some embodiments, the device is configured to house any type of bicycle lock known in the art, for example, but not limited to, a chain lock, a cable lock, a U-lock, and alike.

According to one embodiment, the position of the at least one battery lock element on the battery, and the position of the at least one frame lock element on the seat tube, are such that when the battery is fully installed in a gap defined by a seat tube and a rail close to a rear wheel of the electric bicycle, the at least one battery lock element and the at least one frame lock element correspond to each other in a manner that allows housing of a bicycle lock by both the at least one battery lock element and the at least one frame lock housing element.

According to another embodiment, the position of the at least one battery lock element on the battery, and the position of the at least one frame lock element on the seat tube, are such that when the battery is fully installed in a gap defined by a seat tube and a rail close to a rear wheel of the electric bicycle, housing of a bicycle lock in both the at least one battery lock element and the at least one frame lock element allows in addition housing of the same bicycle lock in the rear wheel of the bicycle.

According to yet another embodiment, the position of the at least one battery lock element on the battery, and the position of the at least one frame lock element on the seat tube, are such that when the battery is fully installed in a gap defined by a seat tube and a rail close to a rear wheel of the electric bicycle, housing of a bicycle lock in both the at least one battery lock element, at least one frame lock housing element, and the rear wheel, allows in addition locking of the electric bicycle to a fixed object.

### BRIEF DESCRIPTION OF THE DRAWINGS

The present invention will be understood and appreciated more comprehensively from the following detailed description taken in conjunction with the appended drawings in which:

FIG. 1A to 1C are schematic side, front perspective and back perspective views, respectively, of a prior art electric bicycle without a battery;

FIG. 2 is a schematic back perspective close-up view of an area adjacent to a seat tube, where a battery is installed in a prior art electric bicycle;

FIG. 3A to 3C are schematic front perspective and back perspective views, respectively, of a prior art electric bicycle with a battery inserted into a gap between by a seat tube and rail, close to a rear wheel of the bicycle;

FIG. 4 is a schematic back perspective close-up view of an area adjacent to a seat tube where a battery is installed in a prior art electric bicycle;

FIGS. 5A and 5B are schematic side and back perspective close-up views, respectively, of an area adjacent to a seat tube, where a battery is installed in an electric bicycle, according to an embodiment of the present invention;

FIGS. 6A and 6B are schematic side and back perspective close-up views, respectively, of an area adjacent to a seat tube, showing a battery in the process of installation in an electric bicycle, according to an embodiment of the present invention;

FIGS. 7A and 7B are schematic side and back perspective close-up views, respectively, of an area adjacent to a seat tube, where a battery is fully installed in an electric bicycle, according to an embodiment of the present invention;

FIGS. 8A and 8B are schematic side and back perspective close-up views, respectively, of an area adjacent to a seat tube, where a battery is fully installed and locked with a u-shaped lock, in an electric bicycle according to an embodiment of the present invention;

FIG. 9 is a schematic back perspective close-up view of an area adjacent to a seat tube of a battery is fully installed and locked with a chain lock in an electric bicycle according to an embodiment of the present invention;

FIGS. 10A and 10B are schematic side and back perspective close-up views, respectively, of an area adjacent to a seat tube, where a battery may be installed in an electric bicycle according to an embodiment of the present invention, illustrating a frame lock element attached to a seat tube;

FIGS. 11A and 11B are schematic side close up and back perspective close-up views, respectively, of an area adjacent to a seat tube, illustrating a frame lock element attached to a seat tube, according to an embodiment of the present invention;

FIGS. 12A and 12B are schematic side and back perspective close-up views, respectively, of an area adjacent to a seat tube where a battery is fully installed and locked with a u-shaped lock, illustrating a frame lock element attached to a seat tube, in an electric bicycle according to an embodiment of the present invention;

FIGS. 13A and 13B are schematic side and back perspective close-up view, respectively, of an area adjacent to a seat tube where a battery is fully installed, illustrating a bolt frame lock element in an open state, according to an embodiment of the present invention;

FIGS. 14A and 14B are schematic side and back perspective close-up views, respectively, of an area adjacent to a seat tube where a battery is fully installed, illustrating a frame lock element comprising a bolt in a closed state, according to an embodiment of the present invention;

FIGS. 15A and 15B are schematic side and back perspective close-up views, respectively, of an area adjacent to a seat tube, where a battery is fully installed, illustrating a bolt frame lock element in a closed state, locked with a u-shaped lock, according to an embodiment of the present invention;

FIG. 16 is a schematic side of an area adjacent to a seat tube where a battery may be installed, illustrating a frame lock element comprising a shaft with at least one perpendicular bolt is attached, in a closed state, according to an embodiment of the present invention;

FIGS. 17A and 17B are schematic side and back perspective close-up views, respectively, of an area adjacent to a seat tube where a battery is being installed, illustrating a shaft frame lock element with a perpendicular bolt, in an open state, according to an embodiment of the present invention;

FIGS. 18A and 18B are schematic side and back perspective close-up views, respectively, of an area adjacent to a seat tube where a battery is fully installed, illustrating a shaft frame lock element with perpendicular bolt, in a closed state, locked with a u-shaped lock, according to an embodiment of the present invention;

FIGS. 19A and 19B are schematic side and back perspective close-up views, respectively, of an area adjacent to a seat tube where a battery is in the process of installation, illustrating a frame lock element attached to a seat tube, according to an embodiment of the present invention;

FIGS. 20A and 20B are schematic side and back perspective close-up views, respectively, of an area adjacent to a seat tube, where a battery is fully installed, illustrating a frame lock element attached to a seat tube, according to an embodiment of the present invention;

FIGS. 21 and 22 are schematic side and back perspective close-up view, respectively, of an area adjacent to a seat tube where a battery is fully installed and locked with a u-shaped lock, illustrating a frame lock element attached to a seat tube, according to an embodiment of the present invention;

FIGS. 23A and 23B are schematic side and back perspective close-up views, respectively, of an area adjacent to a seat tube, where a battery may be installed, without a rail, according to an embodiment of the present invention;

FIGS. 24A and 24B are schematic side and back perspective close-up views, respectively, of an area adjacent to a seat tube, where a battery may be installed, including a rail, according to an embodiment of the present invention.

### DETAILED DESCRIPTION OF THE INVENTION

In a majority of electric bicycles the battery in installed adjacent to a seat tube, thus rendering the battery vulnerable to theft, in addition to theft of the entire electric bicycle, namely the electric bicycle's frame together with at least one of the wheels of the electric bicycle.

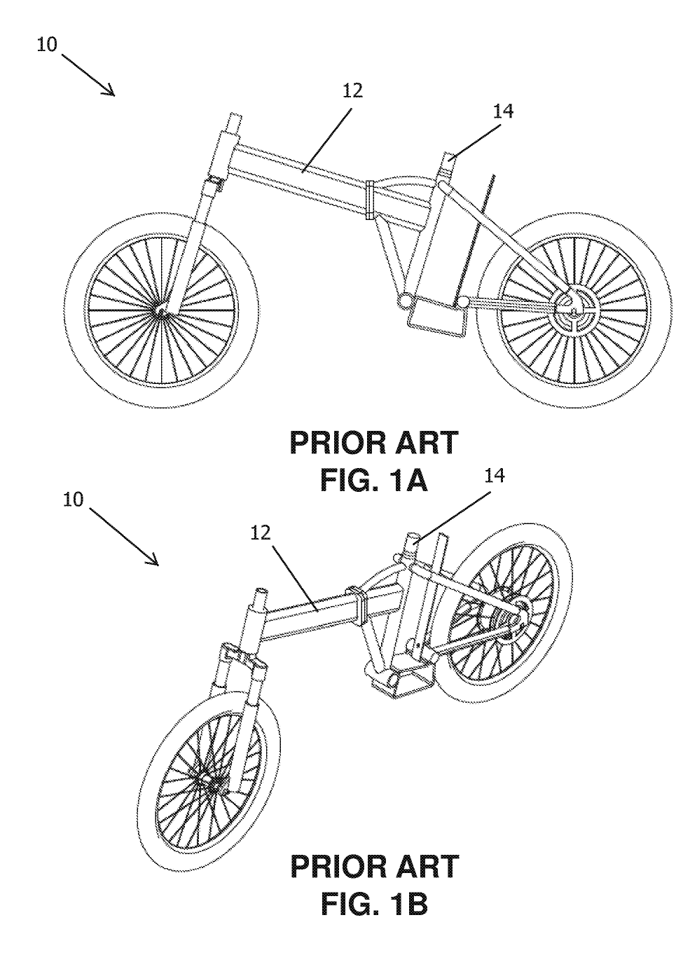

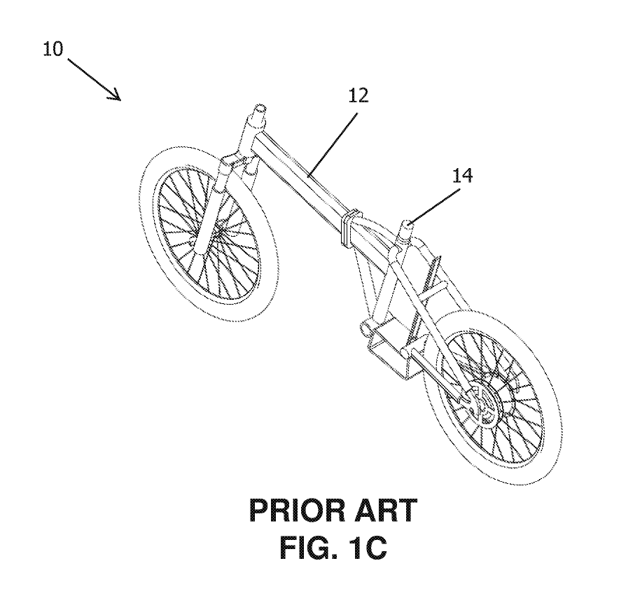

In FIG. 1A to 1C frame 12 of the electric bicycle 10 comprises inter alia a seat tube 14 configured to host a seat post to which a saddle is attached. In a large portion of the electric bicycles, a rail is installed adjacent to the rear wheel. The rail is configured to facilitate sliding of the battery downwards in between the rail and the seat tube.

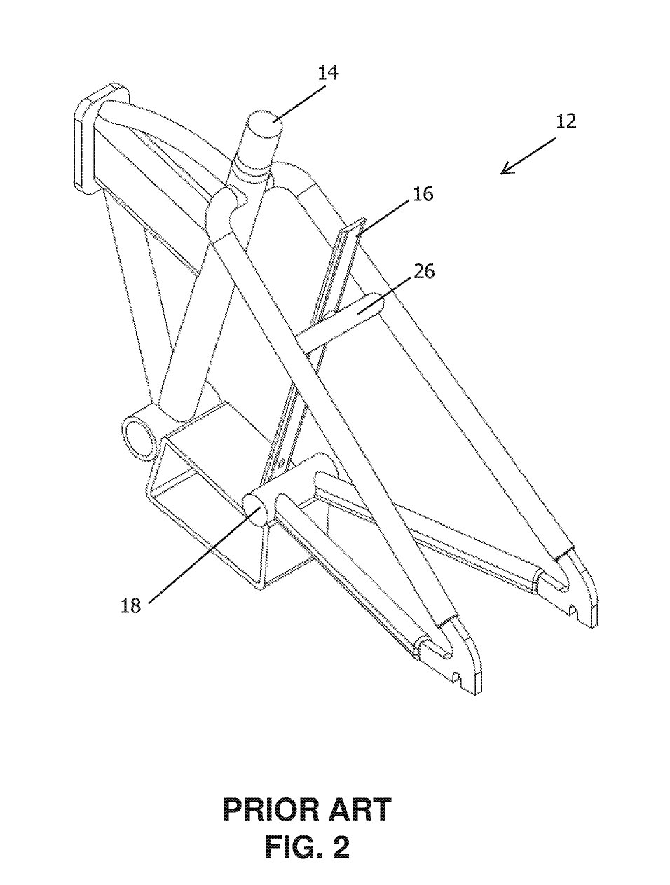

In FIG. 2 rail 16 is attached to bridge 18 connecting two rear forks of the electric bicycle. Rail 16 and seat tube 14 define a gap configured to accommodate a battery (not shown). The gap is close to a rear wheel of the electric bicycle. At the bottom of the gap, between seat tube 14 and rail 16 there is a basis comprising electric contact points (not shown) configured to be in contact with corresponding electric contact points of a battery (not shown) inserted into the gap between seat tube 14 and rail 16.

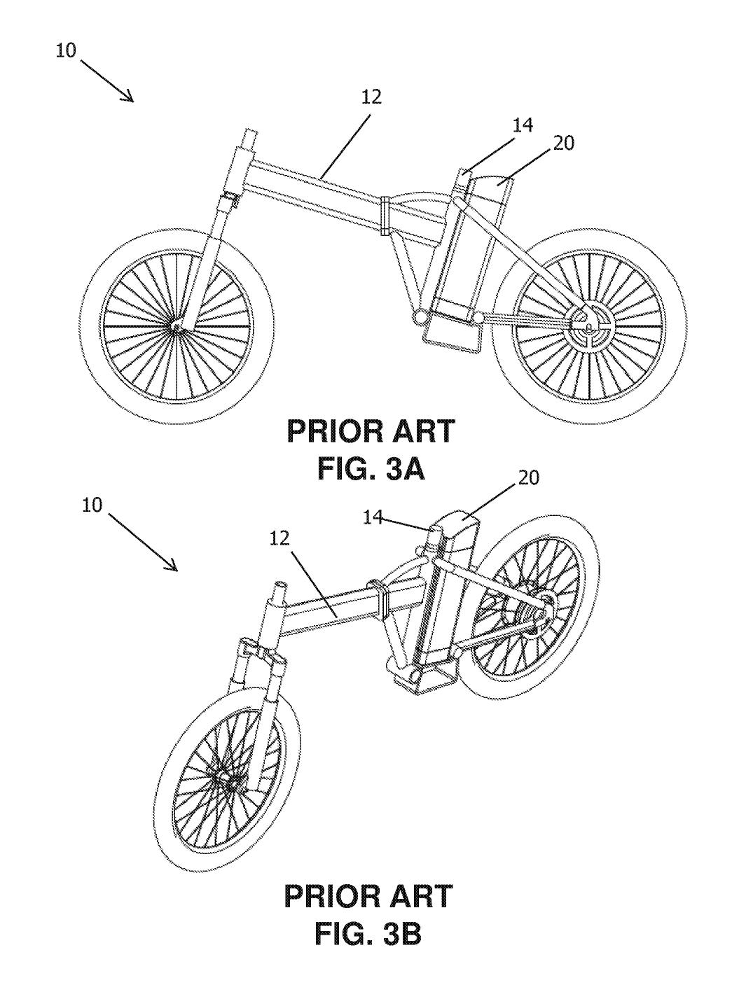

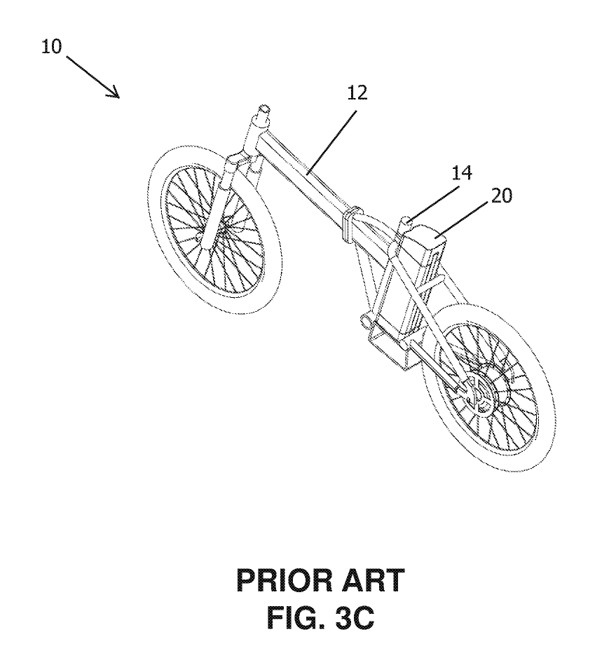

As can be seen in FIG. 3A to 3C, when battery 20 is fully inserted into the gap between seat tube 14 and rail 16, the bottom part of battery 20 is in contact with the basis comprising the electric contact points.

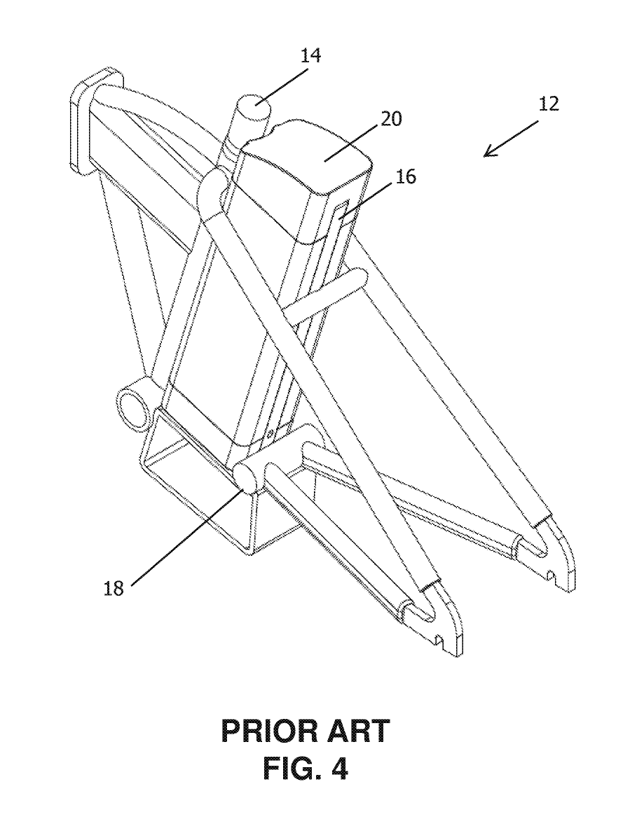

It can be appreciated from FIG. 4 that locking of battery 20, for example by a built-in battery lock, may prevent theft of battery 20, but does not protect from theft of frame 12 of the electric bicycle, theft of a rear wheel (not shown) for example, or theft of both the frame and the rear wheel.

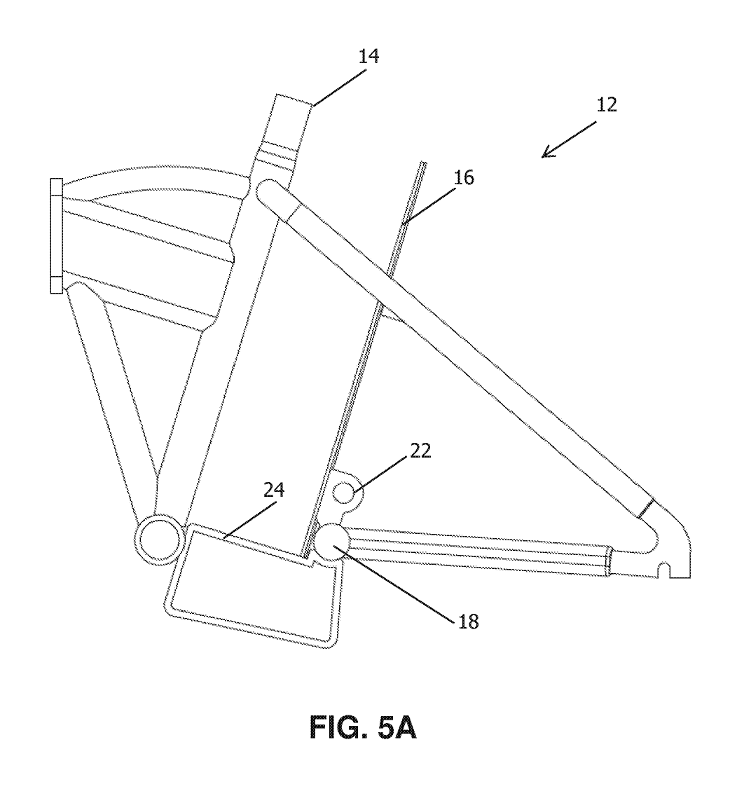

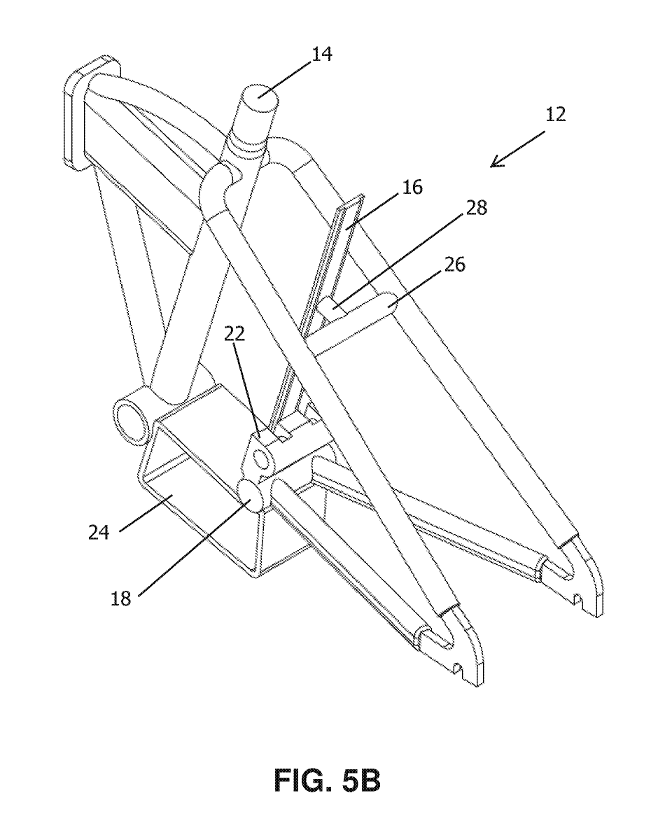

According to an embodiment, illustrated in FIGS. 5A and 5B, the device comprises at least one frame lock element 22 attached to basis 24 with which the bottom part of the battery (not shown) is in electric contact. For the sake of simplicity, it will be mentioned hereinafter that the at least one frame lock element 22 is attached to frame 12.

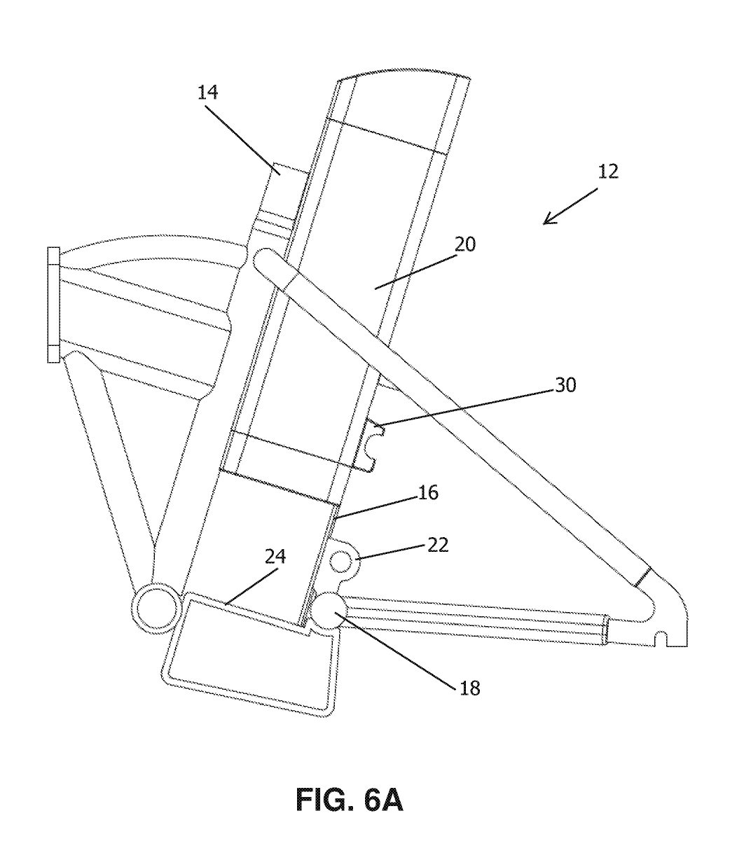

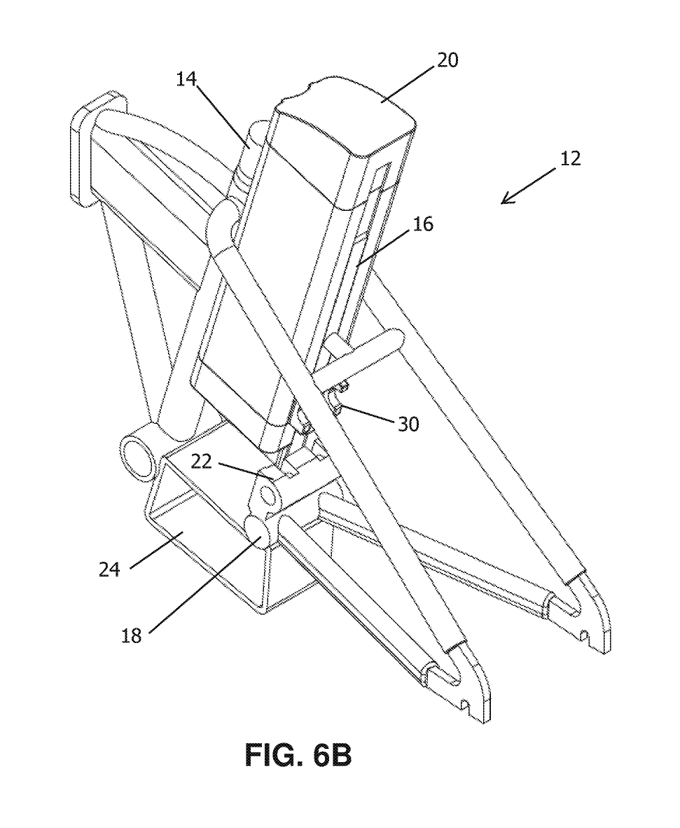

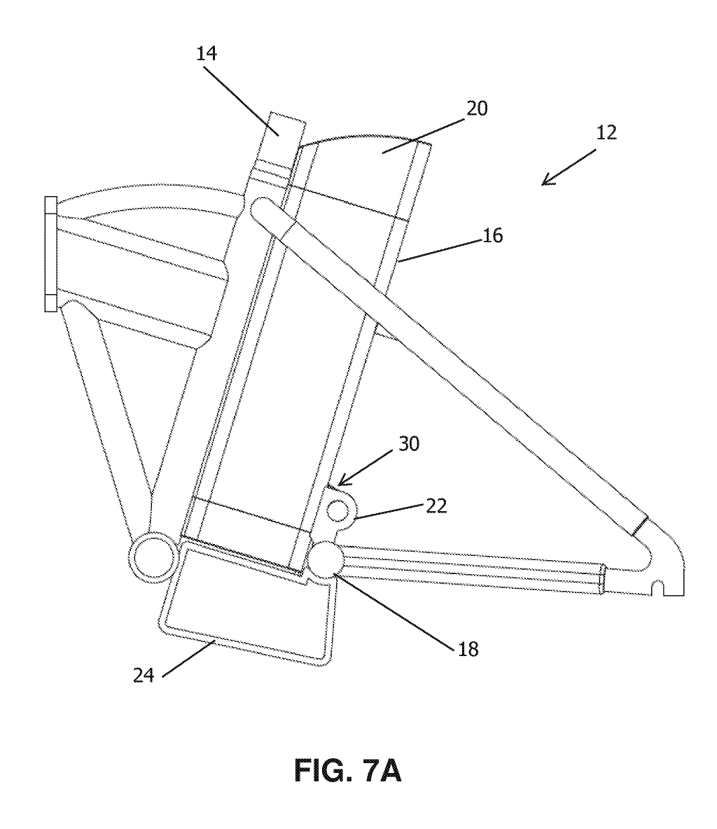

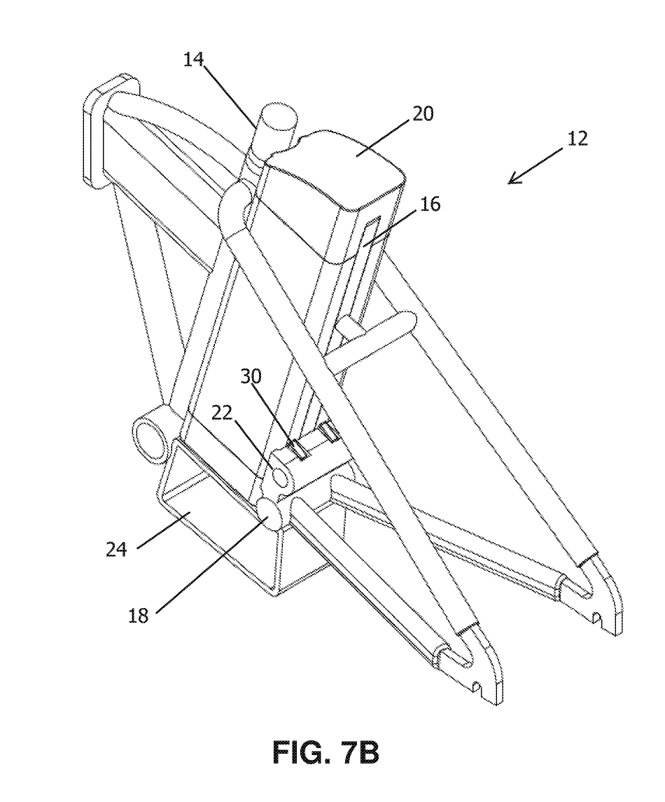

As illustrated in FIGS. 6A and 6B, the device further comprises at least one battery lock element 30 attached to battery 20. As can be seen in FIGS. 7A and 7B, at least one battery lock element 30 and at least one frame lock element 22 are configured to be aligned in a manner that allows insertion of a bicycle lock into both, at least one battery lock element 30 and at least one frame lock element 22.

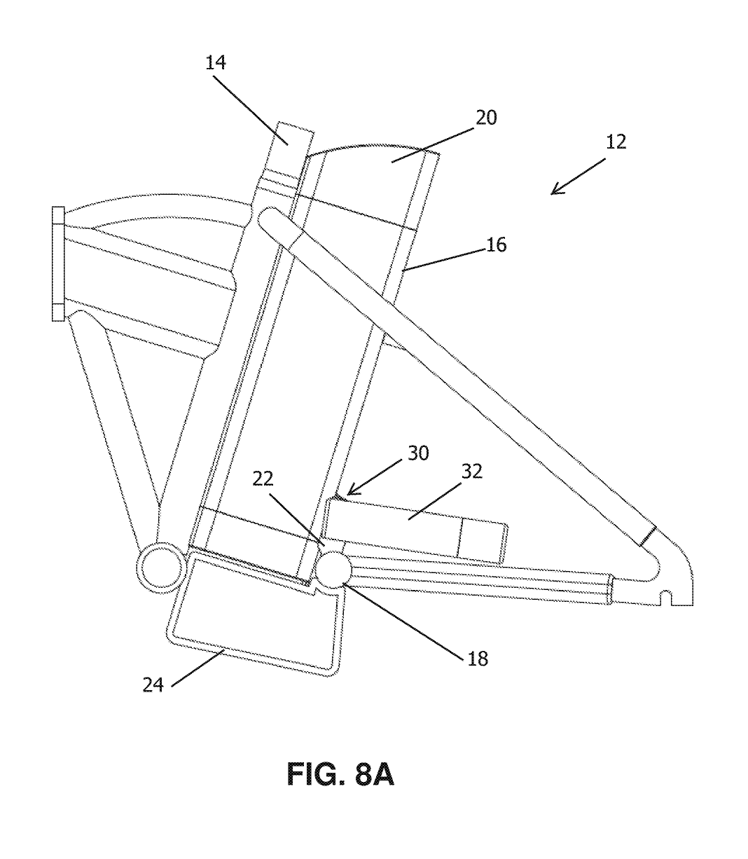

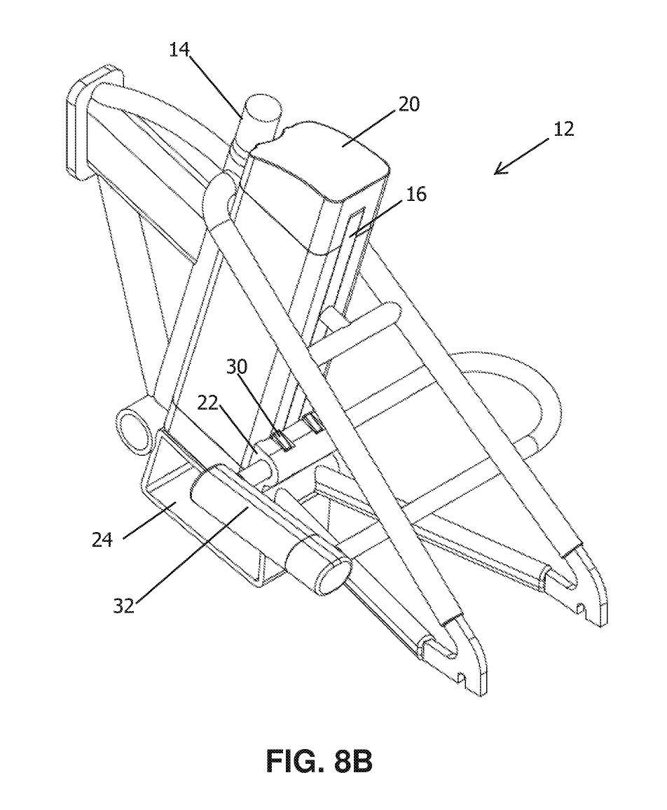

This feature of the present invention is advantageous over currently available prior art solutions for locking a battery of an electric bicycle, like the solution of locking the battery with a cable lock through the battery handle, known in the art. As can be seen in FIGS. 8A and 8B, according to the present invention, the alignment of at least one battery lock element 30 with at least one frame lock element 22 allows mutual protection of both of them against breakage. When a lock, for example U-shaped lock 32, is inserted into at least one battery lock element 30 and at least one frame lock element 22, access to and easy breakage of at least one battery lock element 30 and/or at least one frame lock element 22 is eliminated due to the mutual coverage of these lock housing elements, as well as due to their close interaction with the lock, such as U-shaped lock 32. Furthermore, it should be noted that according to some embodiments, the location of the at least one battery lock element is not adjacent to the battery handle that is highly exposed and vulnerable to breakage but rather in a less exposed area, adjacent to rail 16 that defines together with seat tube 14 the gap in which battery 20 is installed.

The shape of the at least one battery lock element and the at least one frame lock element may include any shape known that is configured to house any bicycle lock known in the art. Examples of a shape of the at least one battery lock element and the at least one frame lock element include, but not limited to, a ring, loop, a hook, and the like, or any combination thereof when there is more than one battery lock element and/or more than one frame lock housing element. The size of the at least one battery lock element and the at least one frame lock element is any size that allows housing of any bicycle lock known in the art.

According to the embodiments illustrated in FIG. 6A to 8B, the at least one battery lock element 22 protrudes from the surface of battery 20. Turning now for example to FIG. 2, it is appreciated that battery 20 comprising at least one protruding battery lock element, such as element 22 shown in FIG. 6A to 8B, cannot be installed in the gap defined by the seat tube 14 and rail 16 because bridge 26 to which rail 16 is attached would block the passage of at least one protruding battery lock element when the battery is inserted into the gap defined by seat tube 14 and the rail 16. Turning now for example to FIG. 5B, rail 16 is distanced from bridge 26 by a distancing element 28 attached in between rail 16 and bridge 26. Thus, during insertion of battery 20 into the gap defined by seat tube 14 and rail 16, as illustrated in FIG. 5B, battery 20 may be installed freely, without blocking the passage of the at least one protruding battery lock element 22 by bridge 26.

The attachment of the at least one battery lock element to the battery and the attachment of the at least one frame lock element to the frame, is achieved by any method and technique known in the art, for example, but not limited to, welding, gluing, and the like. According to some embodiments, the battery comprises a battery case in which cells of the battery are accommodated. According to these embodiments, the at least one battery lock element is attached to the battery case by any method and technique known in the art, as described above. According to an additional embodiment, the battery case and the at least one battery lock element are manufactured as one piece by any method and technique known in the art, for example, but not limited to, gnawing of a piece of material, casting a melted material in a mold, and the like. Similarly, according to a further embodiment, the frame, or more particularly the at least one part of the basis with which the bottom part of the battery is in electric contact, and the at least one frame lock housing element, are manufactured as one piece by any method and technique known in the art, as described above.

According to some embodiments, the at least one battery lock element and the at least one frame lock element are made of any material that is configured to withstand breakage, for example during an attempt to steal the battery. According to some other embodiments, the at least one battery lock element and the at least one frame lock element are made of any material that is configured to withstand removal of each lock housing element. Exemplary materials of which the at least one battery lock element and the at least one frame lock element are made, include: a metal such as aluminum, steel, and alike; rigid plastics, carbon fiber and any combination thereof. According to some embodiments, the material of which the at least one frame lock element is made of may be different from the material of which the frame is made. Nevertheless, according to some embodiments, the at least one frame lock element is considered as part of the frame.

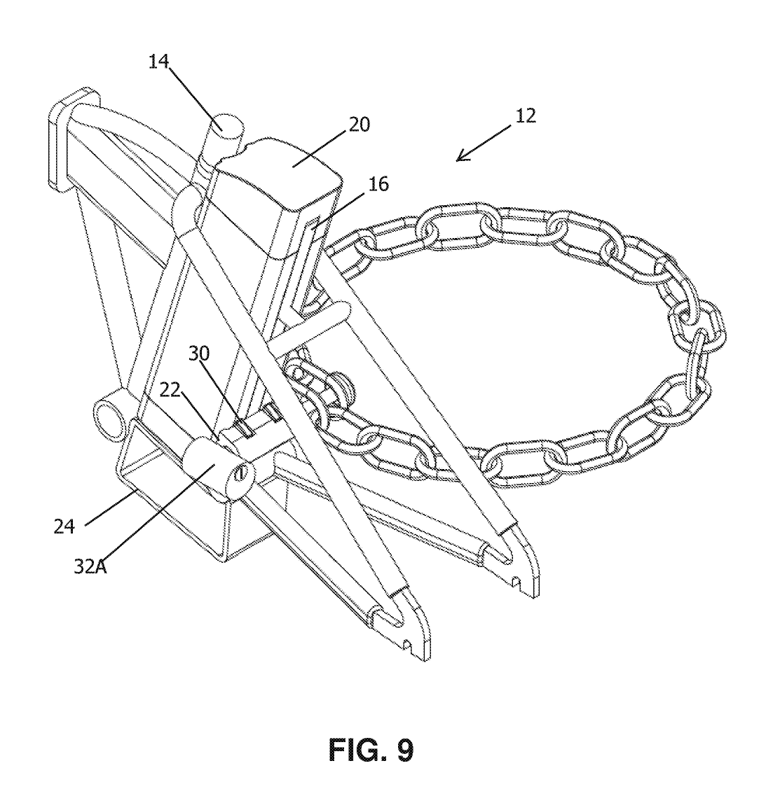

Referring to FIG. 9, according to another embodiment, when battery 20 is installed in a gap defined by seat tube 14 and a rail 16 close to the rear wheel (not shown) installed on frame 12, at least one frame lock element 22 and at least one battery lock element 30 are adjacent to the rear wheel (not shown) of the electric bicycle in a manner that allows accommodating bicycle lock 34 in and through the rear wheel (not shown), while the bicycle lock is housed in both, at least one battery lock element 30 and the at least one frame lock element 22. Thus, locking of these three components, namely battery 20, frame 12 and the rear wheel (not shown) of electric bicycle 10, is achieved with single bicycle lock 32A.

According to a preferred embodiment, the bicycle lock that is used with the device of the present invention is further configured to be locked to a fixed object, like a column, a bicycle stand, a loop attached to a wall, a tree, and the like. Thus, locking of the three components of the electric bicycle—the battery, the frame and the rear wheel, to a fixed object is achieved with only one bicycle lock.

It should be noted that the example of locking the battery, the frame and the rear wheel with only one bicycle lock does not limit the scope of the present invention only to this embodiment. According to some embodiments, the present invention allows locking of only the battery with the frame of the bicycle, depending on the size and shape of the lock being used. According to other embodiments, the present invention allows locking of the battery together with the frame of the bicycle to a fixed object, depending on the size and shape of the lock being used. According to some other embodiments, the device of present invention allows locking any part of the bicycle in addition to locking the battery with the frame, either by using a single lock, or a plurality of locks.

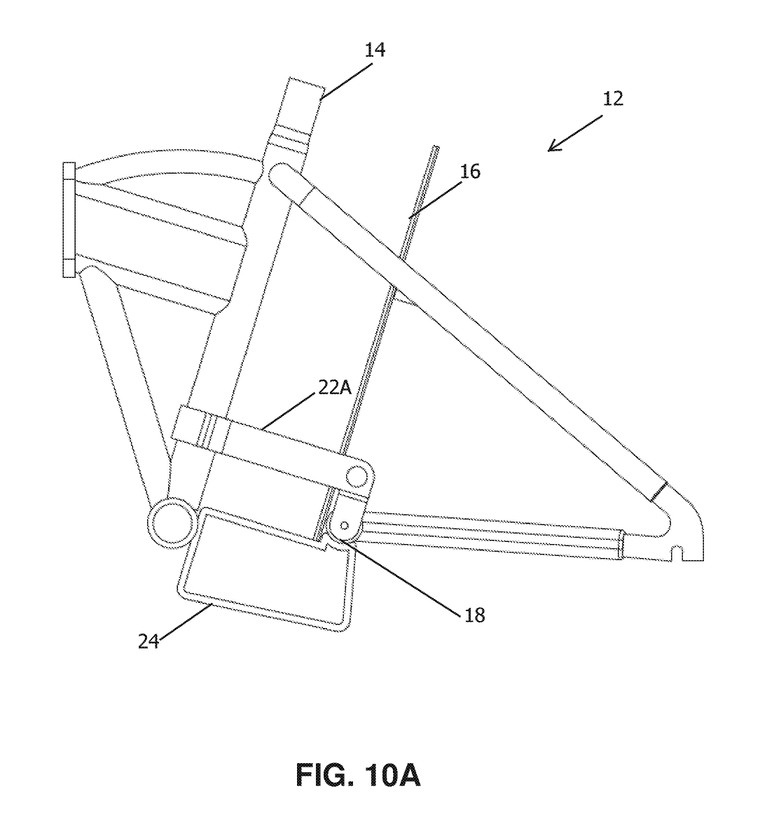

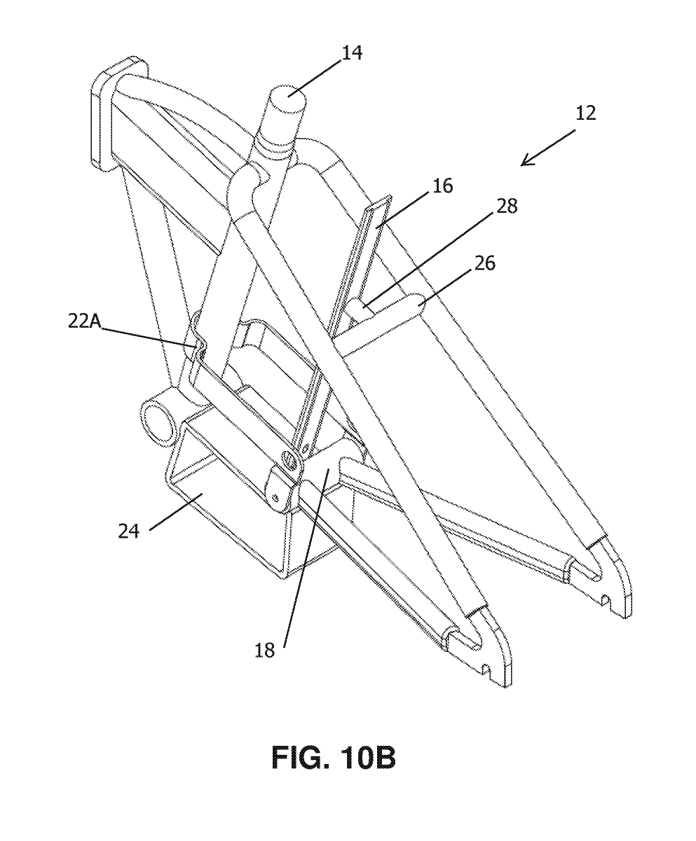

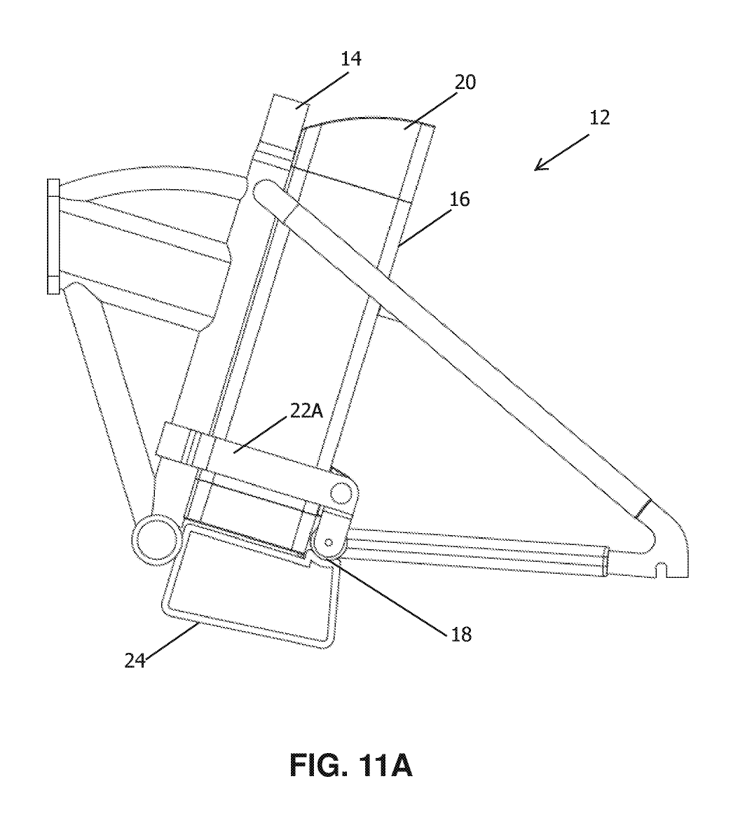

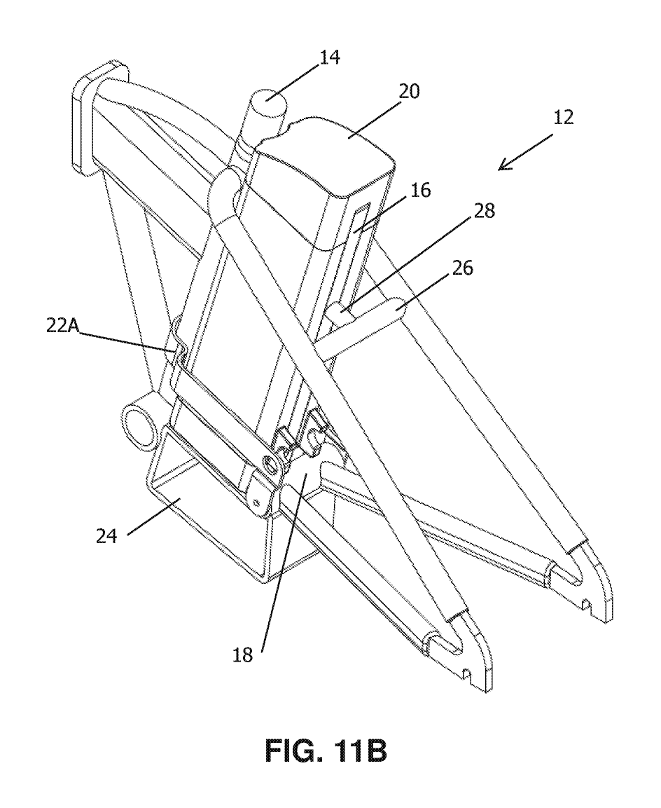

Referring to FIG. 10A to 11B, according to one embodiment, frame lock element 22A is attached to seat tube 14. According to the embodiment illustrated in FIG. 10A to 11B, the frame lock element 22A is U-shaped attached to seat tube 14 and comprising two elongated arms with a hole at a distal end of each arm. As the U-shaped element is attached to seat tube 14, it forms a part of frame 12, even in cases when U-shaped element 22A is a different part than seat tube 14. The two elongated arms of U-shaped element 22A are configured to at least partially surround battery 20, while the holes at the distal ends of the arms of element 22A correspond to at least one battery lock element 30 protruding from battery 20, when battery 20 is fully installed into the gap between seat tube 14 and rail 16 close to the rear wheel (not shown).

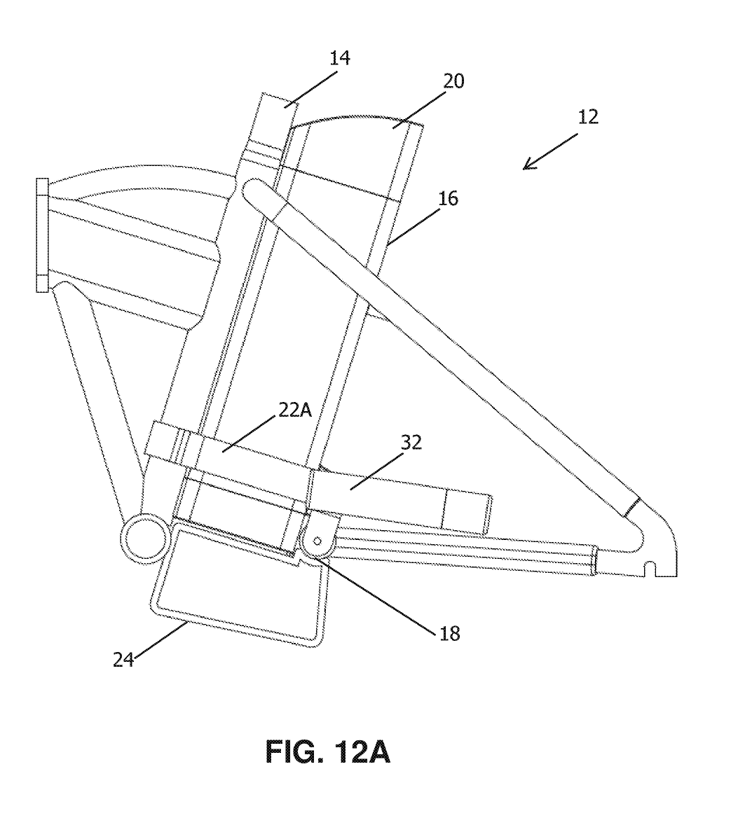

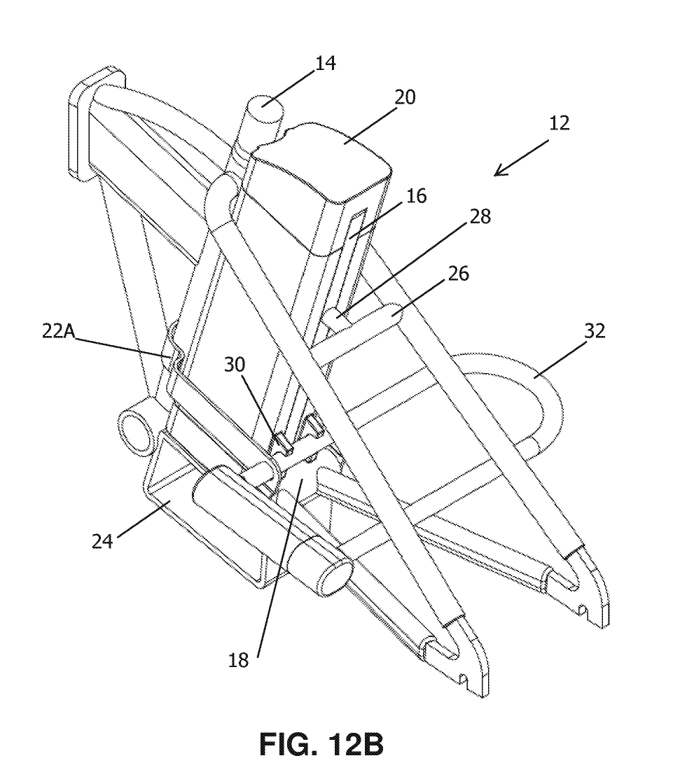

As illustrated in FIGS. 12A and 12B, the correspondence of the holes at the distal ends of the arms of frame lock element 22A with at least one protruding battery lock element 30 allows locking of battery 20, frame 12 and potentially the rear wheel (not shown) with a single lock, such as U-shaped lock 32.

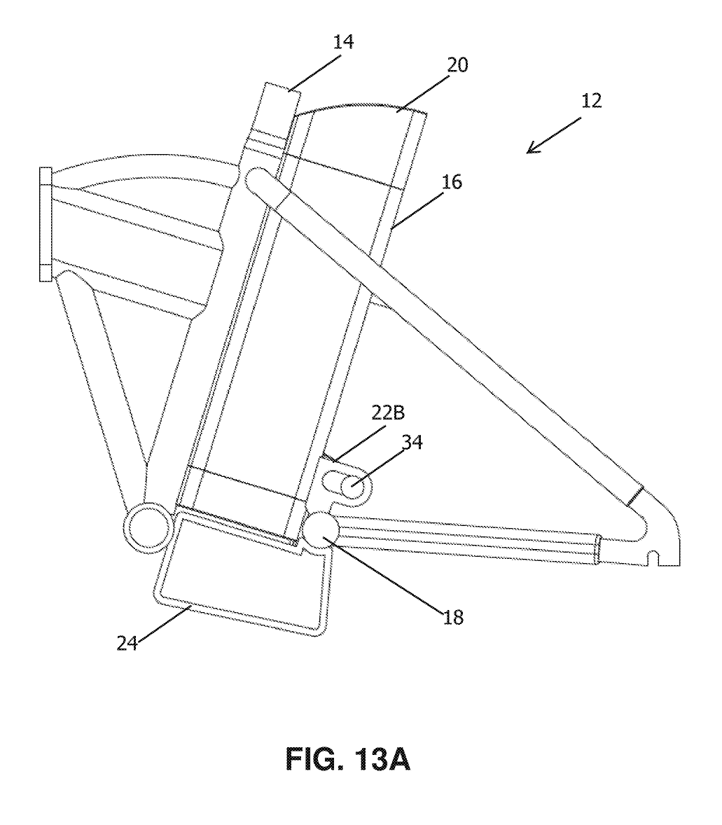

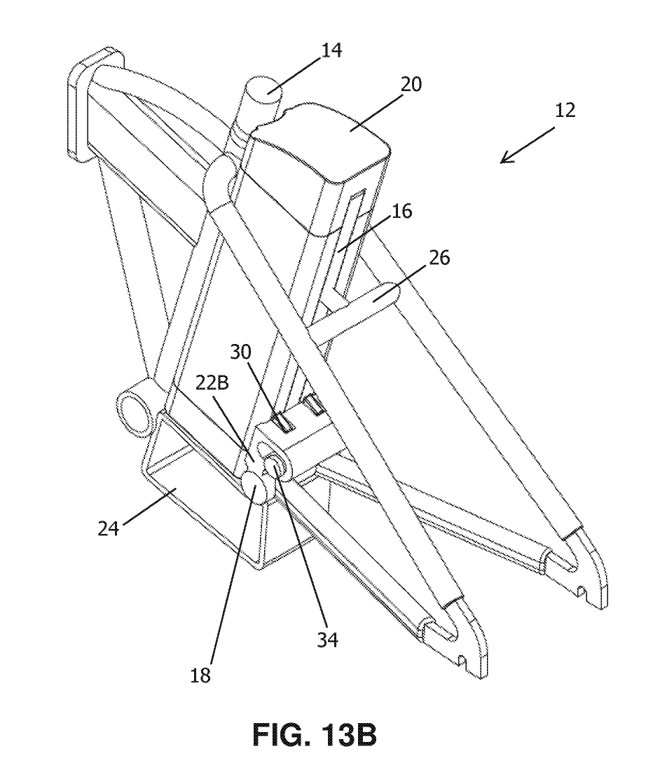

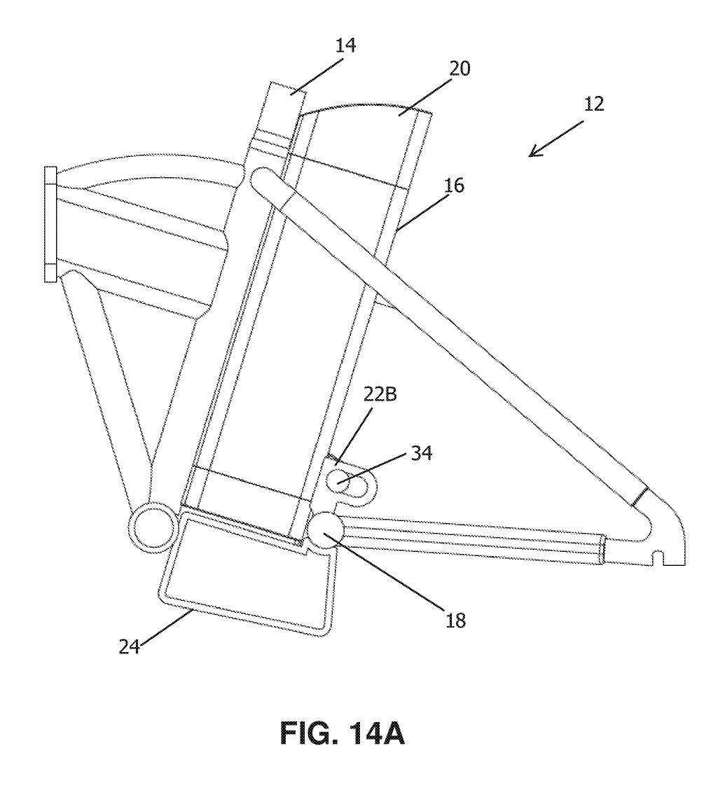

According to the embodiment illustrated in FIG. 13A to 15B, frame lock element 22B embodies a tube-like structure, comprising at least one slot configured to receive at least one protruding battery lock element 30 when battery 20 is fully installed in the gap between seat tube 14 and rail close 16 to rear wheel (not shown). In this embodiment, at least one protruding battery lock element 30 is a hook. The frame lock element 22B comprises an inner hollow space. In a side view, illustrated in FIG. 13A, the inner hollow space of element 22B is preferably oval-shaped. Moreover, the inner hollow space of element 22B is larger than at least one protruding battery 30 lock housing element. In the inner hollow space of element 22B there is shaft 34 functioning as a bolt. The bolt may be either in an open state or a locked state. In the open state, shown in FIGS. 13A and 13B, shaft 34 is positioned in a side portion of the inner hollow space in element 22B distant from battery 20. In this state, battery 20 may be installed and at least one protruding battery lock element 30 is received by the slots of the frame lock element 22B, when at least one battery lock element 30 is aligned with the inner hollow space of element 22B.

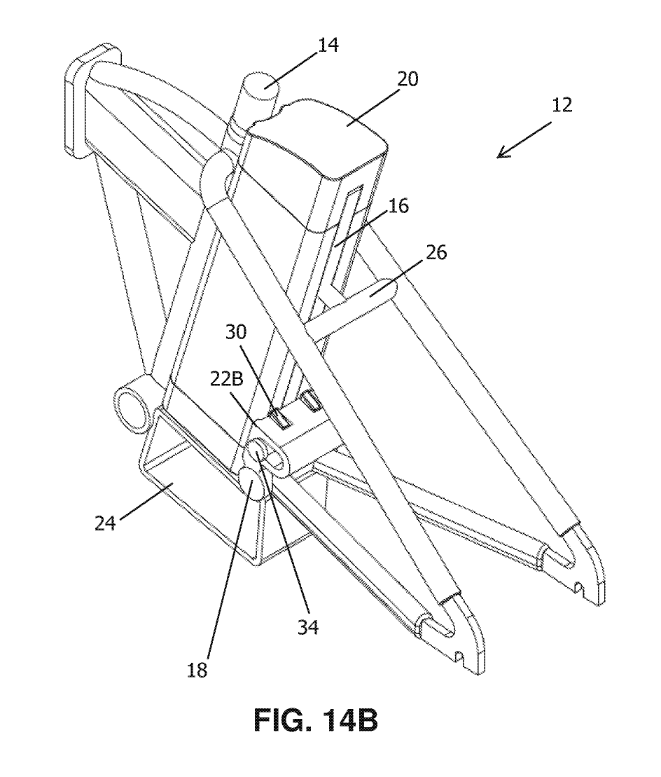

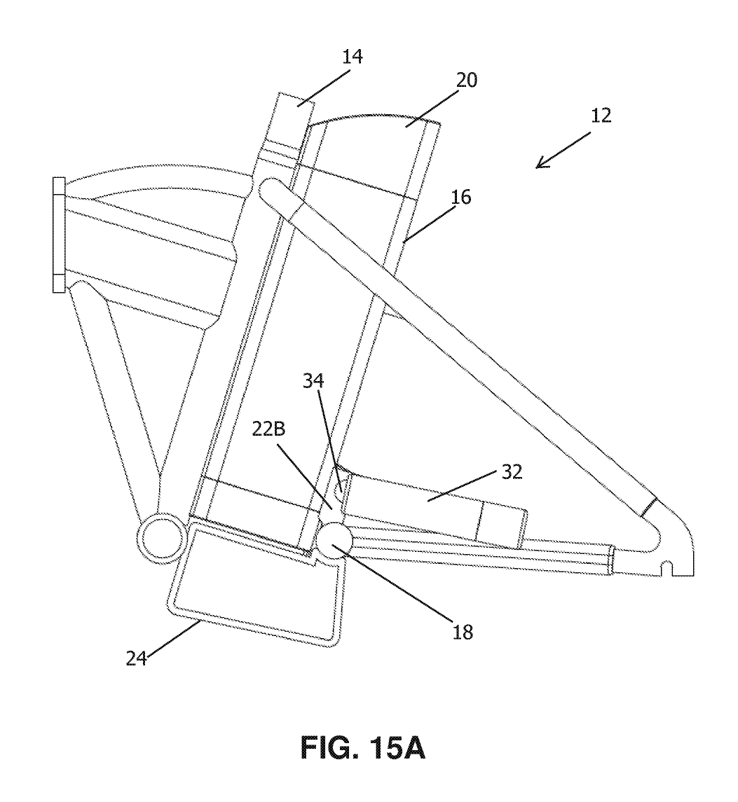

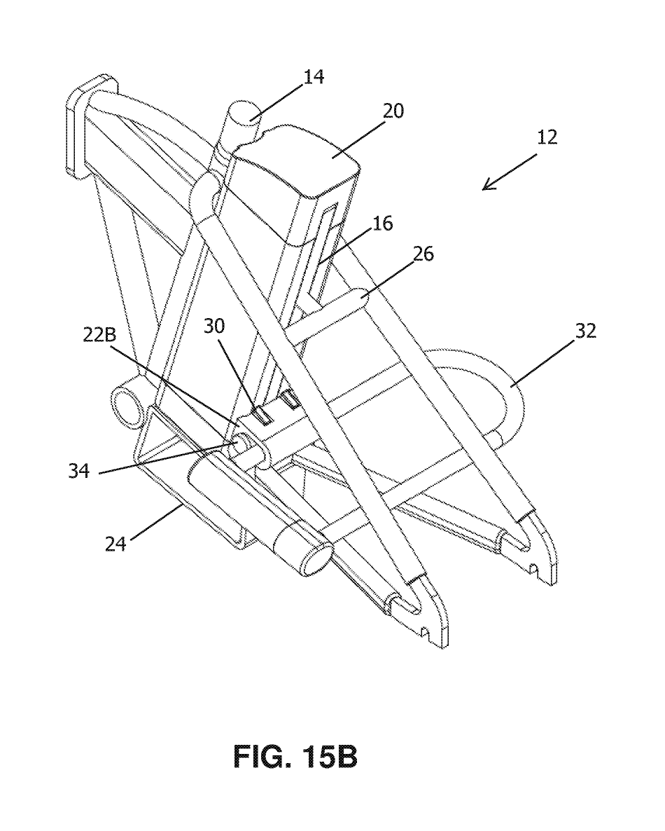

In the configuration shown in FIG. 14A to 15B, shaft 34 of the bolt is moved to the side of the inner hollow space in element 22B that is close to battery 20. In this state, shaft 34 of the bolt engages with the at least one battery lock element 30 and prevents pulling out battery 20 from the installed position. In order to further secure the closed state of shaft 34, lock 32 may be inserted into the remaining portion of the inner hollow space, as shown in FIGS. 15A and 15B.

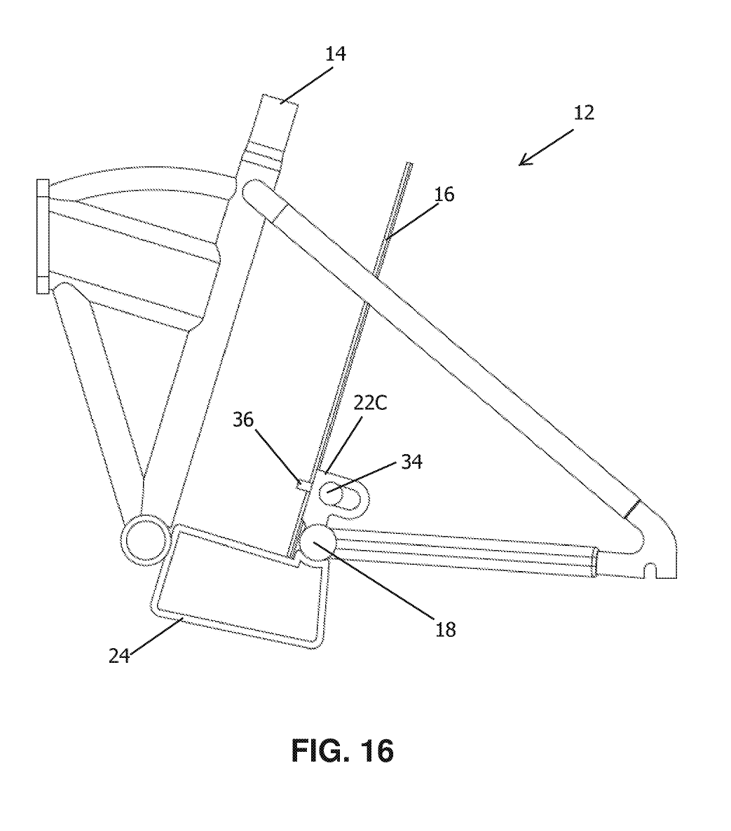

According to another embodiment, illustrated in FIGS. 16 to 18B, frame lock element 22C is similar to frame lock element 22B shown in FIG. 13A to 15B, except that shaft 34 in the inner hollow space of element 22C does not engage with a battery lock element per se. Instead, at least one perpendicular bolt 36 is attached to shaft 34. At least one slot (not shown) in frame lock element 22C is configured to allow at least one perpendicular bolt 36 to extend into the gap between seat tube 14 and element 22C, when shaft 34 is positioned in the side of the inner hollow space in element 22C that is close to battery 20.

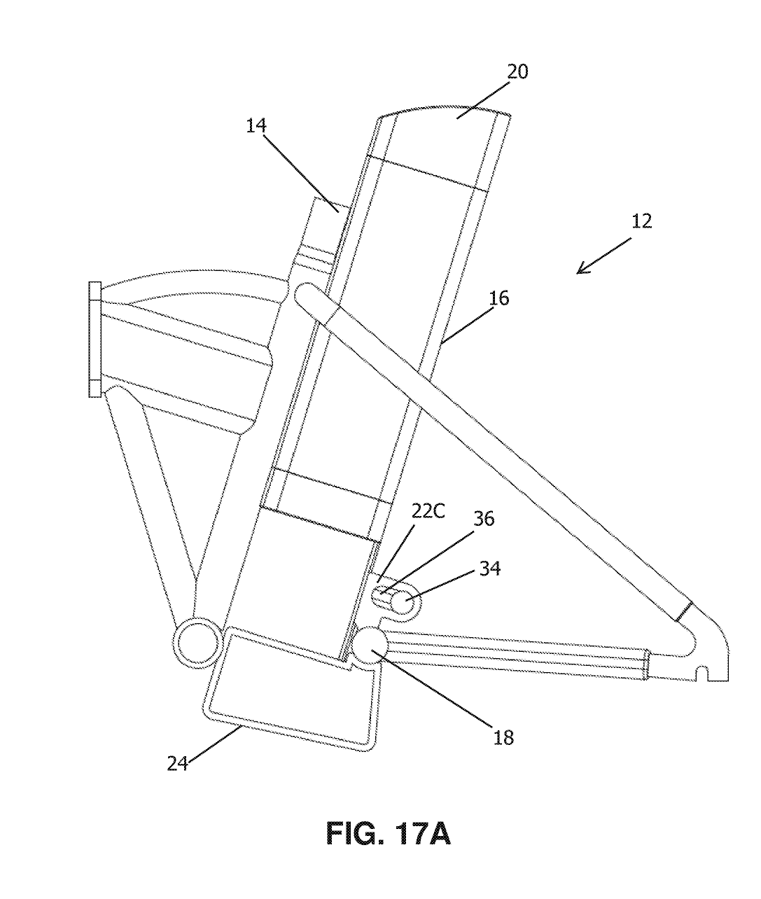

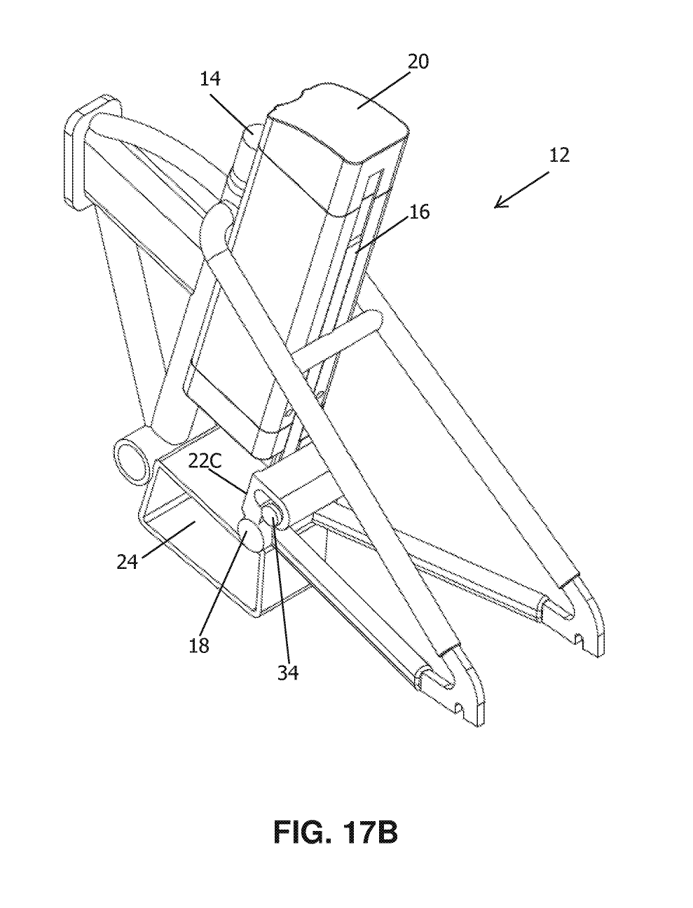

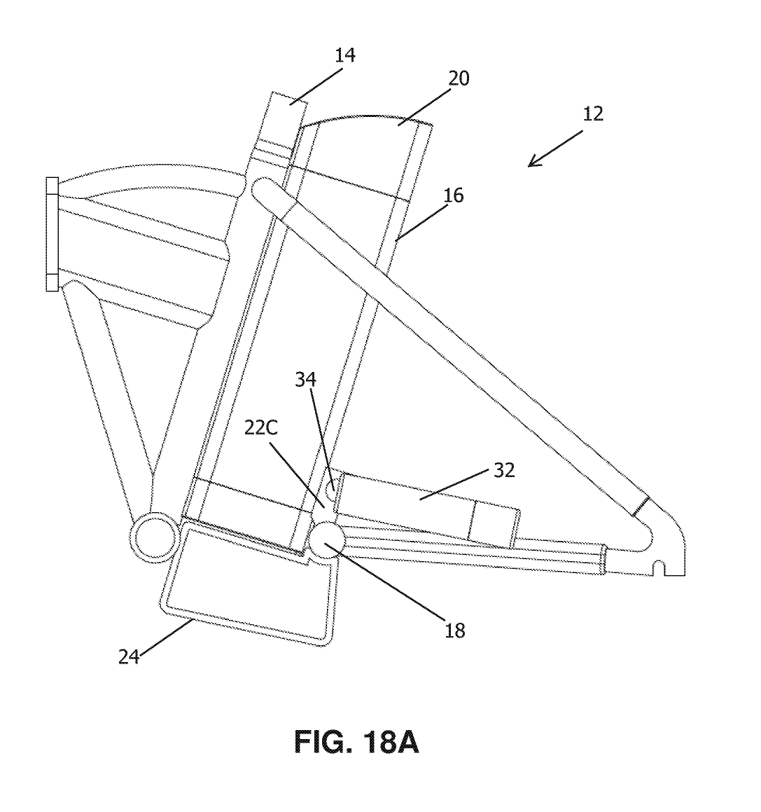

Referring to FIGS. 17A and 17B, shaft 34 is positioned in the side of the inner hollow space in element 22C that is distant from battery 20. In this state, at least one perpendicular bolt 36 does not extend through the slot in frame lock housing element 22C and battery 20 can be installed. The at least one battery lock element comprises an aperture (not shown) configured to receive at least one perpendicular bolt 36 when battery 20 is installed and shaft 34 is in a closed conformation. As in this embodiment at least one battery lock element does not protrude from the surface of battery 20, there is no need to distance rail 16 from bridge 26 and therefore rail 16 is attached directly to bridge 26, similarly to prior art electrical bicycles, for example shown in FIG. 2.

To lock battery 20 after fully inserting into the gap between seat tube 14 and rail 16 near the rear wheel (not shown), shaft 34 comprising the at least one perpendicular bolt 36 is positioned in the closed state, namely in a side portion of the inner hollow space in element 22C that is close to battery 20, as shown in FIG. 16. Thus, at least one perpendicular bolt 36 extends from the frame lock element 22C and inserted into at least one hole in battery 20, thus preventing pulling out of battery 20 from the installed position.

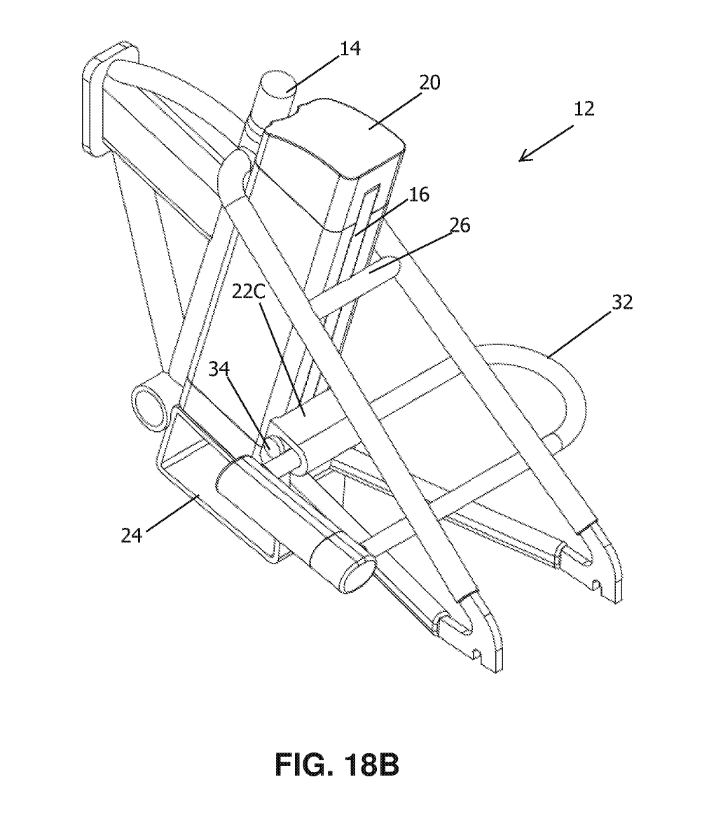

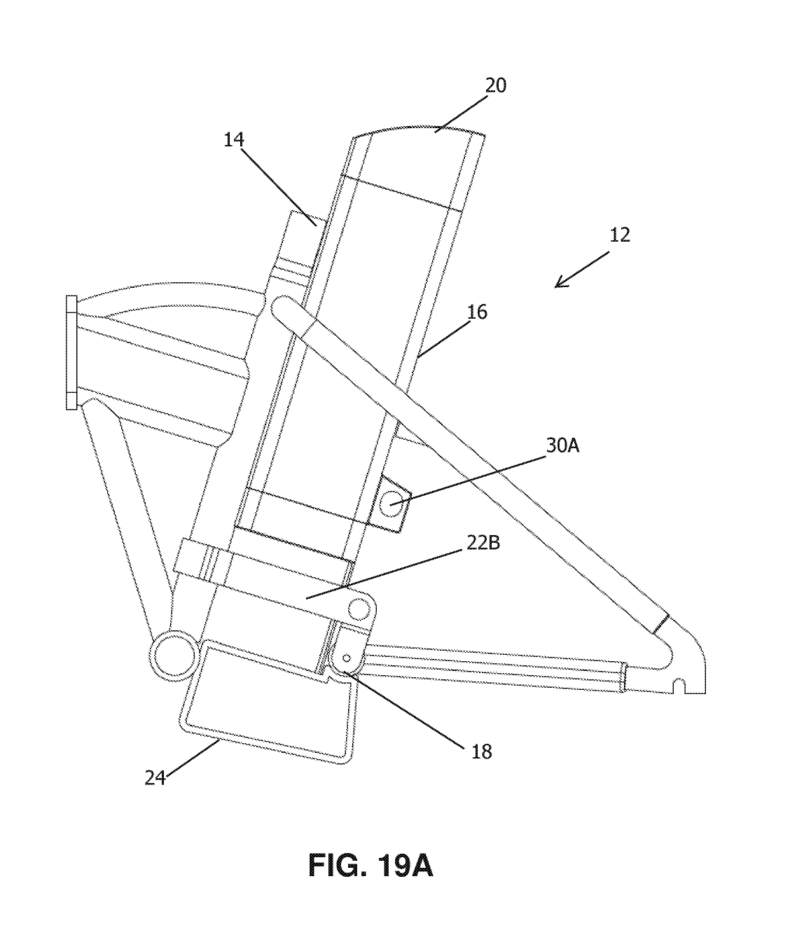

In order to secure the closed state of the shaft with at least one perpendicular bolt 36, lock 32 is inserted into the remaining of the inner hollow space in element 22C. In configuration shown in FIGS. 18A and 18B, U-shaped lock 32 is inserted into the remaining of the inner hollow space in element 22C, when shaft 34 with at least one perpendicular bolt 36 is in a closed state. Thus, locking battery 20, frame 12 and the rear wheel (not shown) by single lock 32.

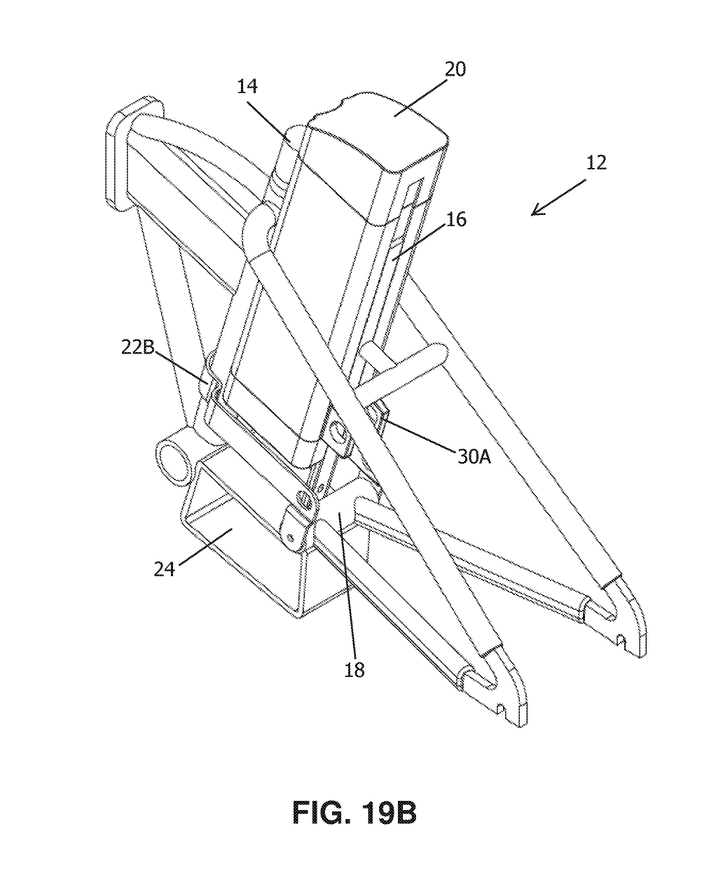

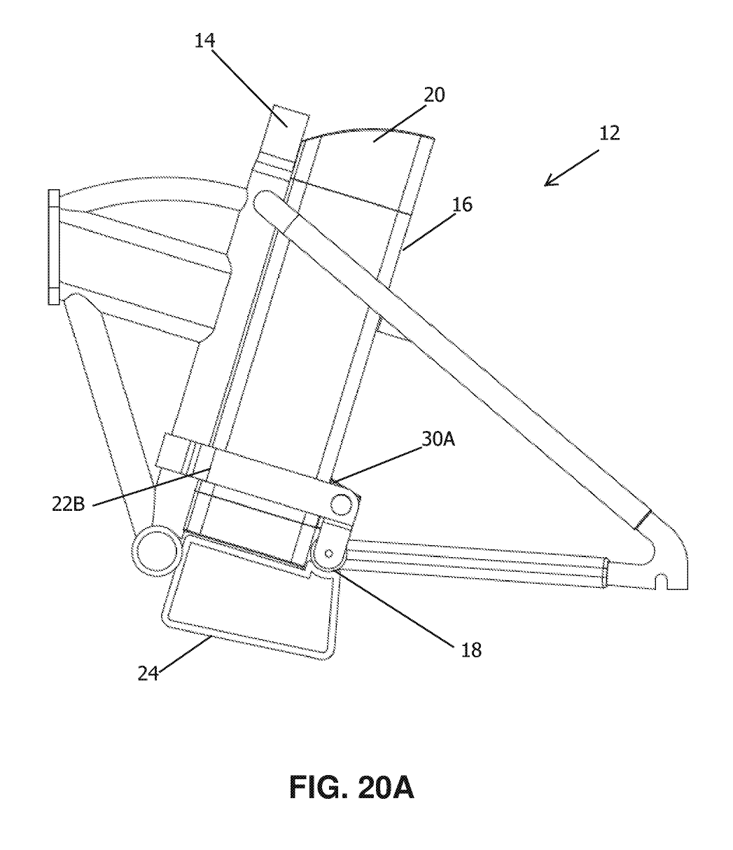

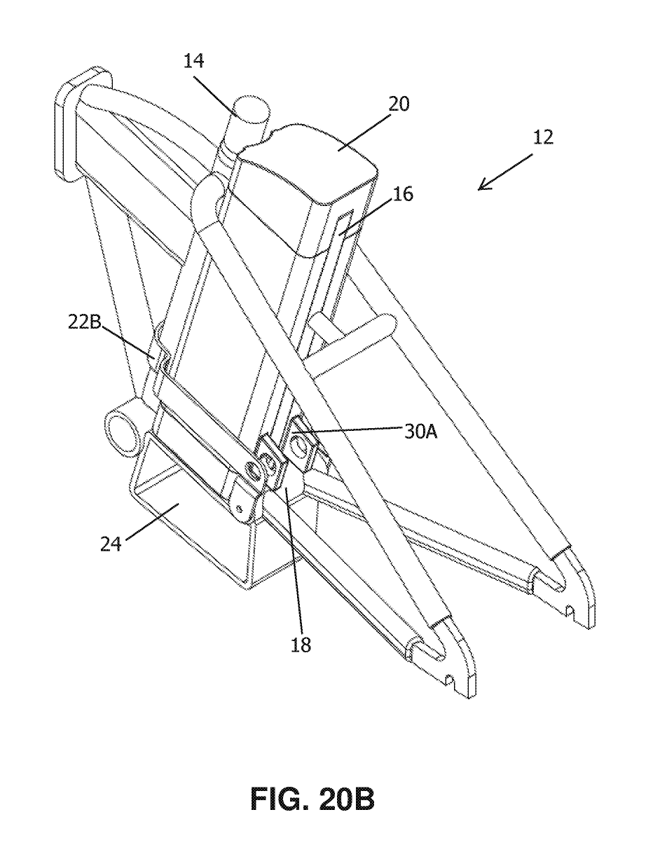

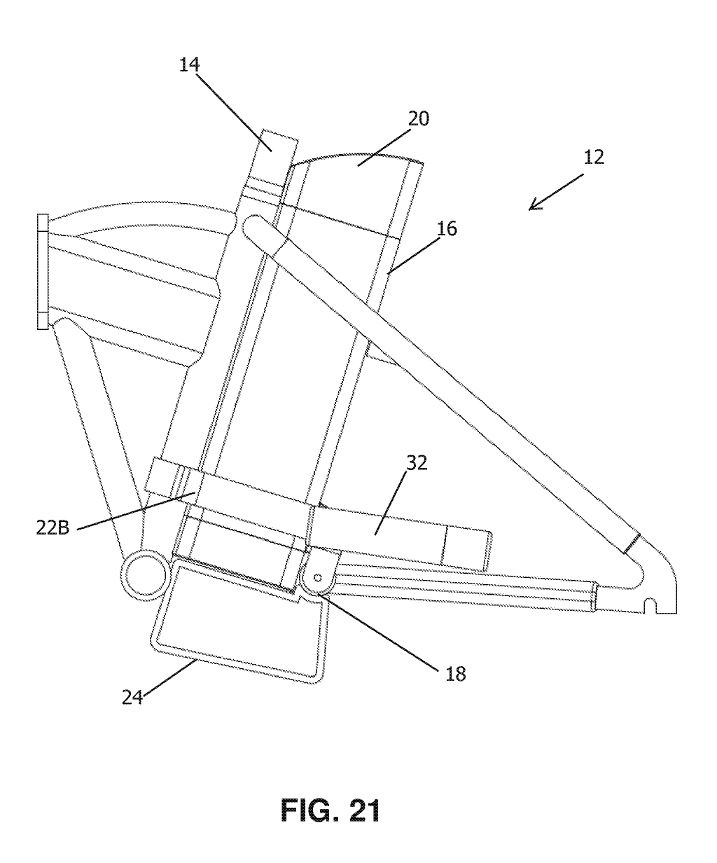

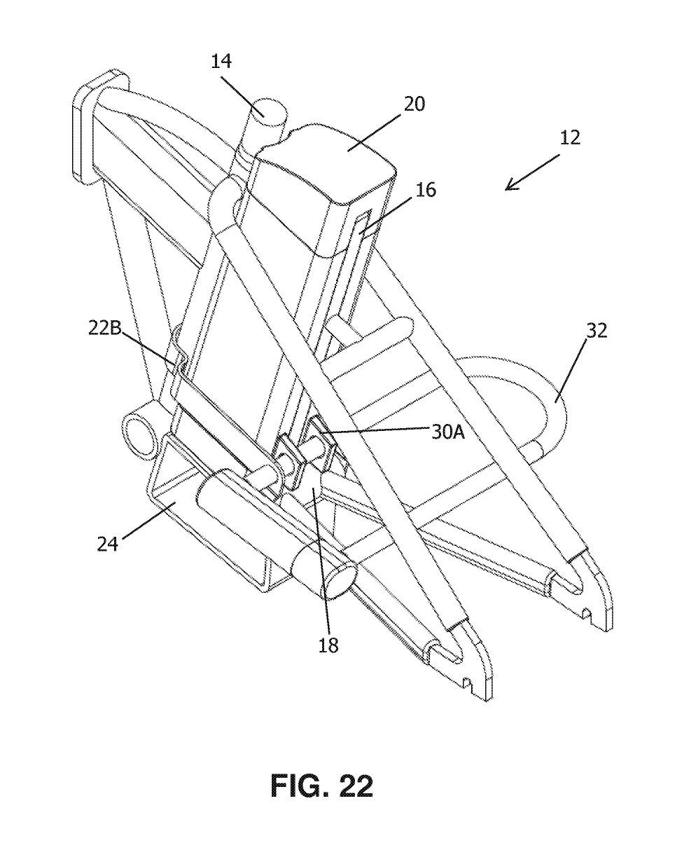

As shown in FIGS. 6A and 11B, protruding battery lock element 30 embodies a hook shape. However, in some embodiments the protruding battery lock element 30 optionally embodies a ring structure. In the embodiment shown through FIGS. 19 to 22, battery lock element 30A embodies a ring structure. It is noted that the ring structured battery lock element 30A illustrated in FIGS. 19 to 22 is equally applicable to all embodiments of the anti-theft device described herein.

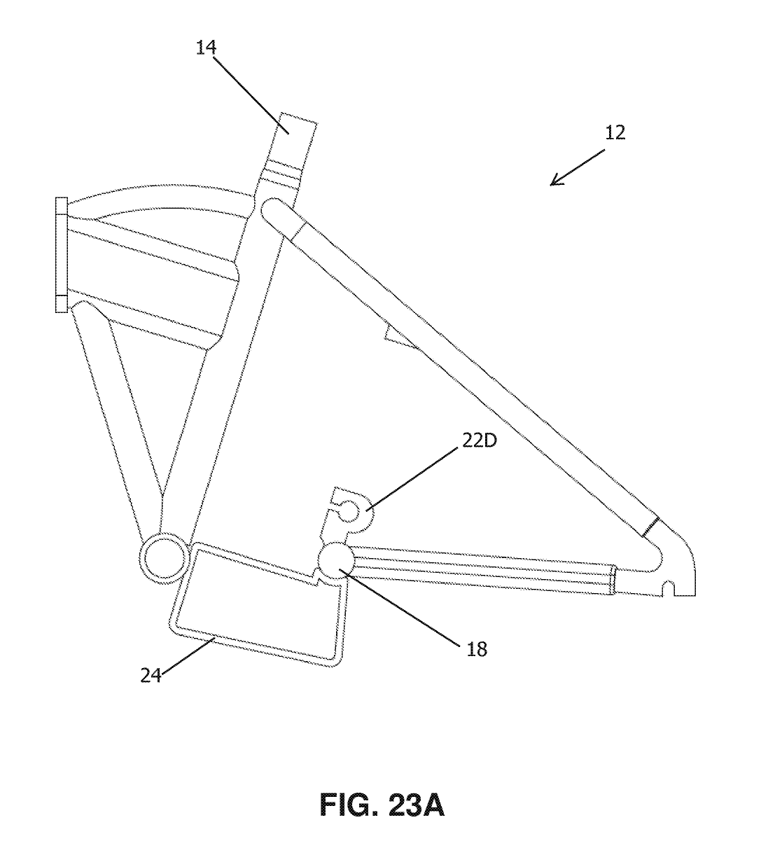

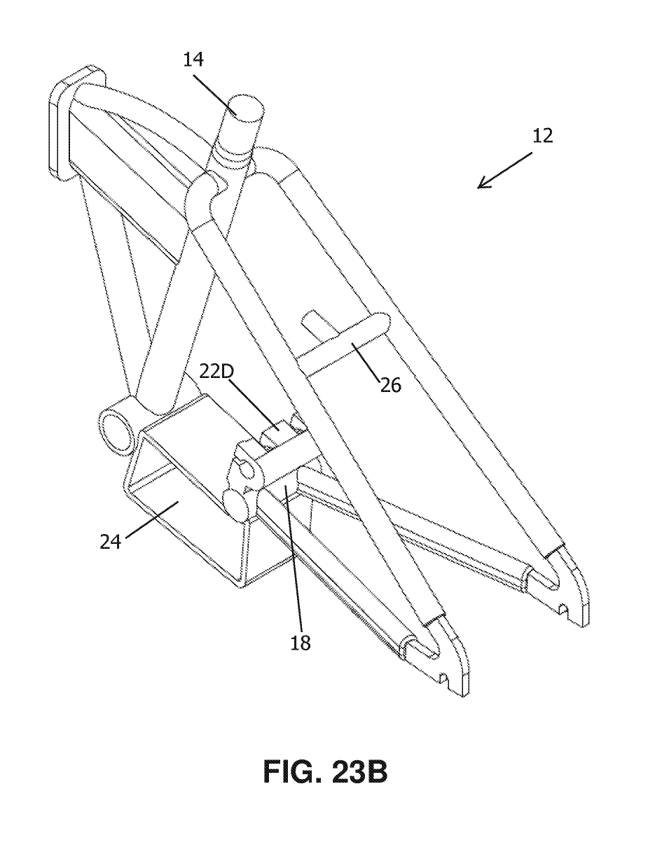

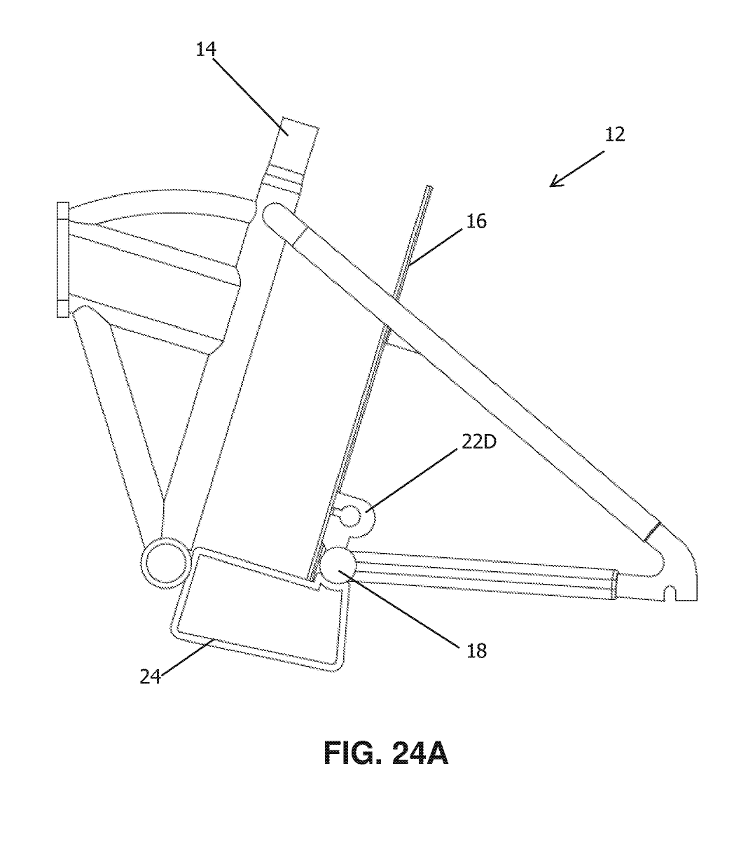

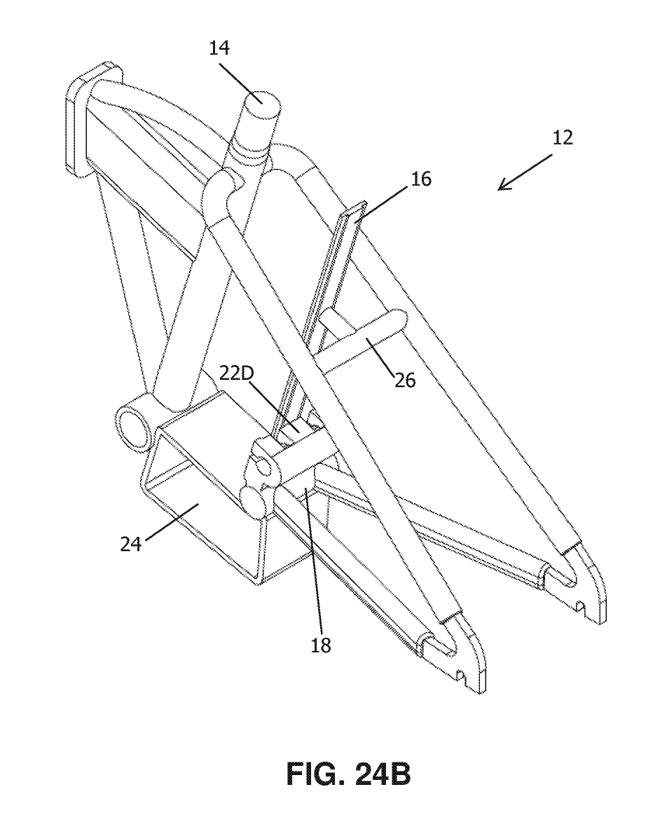

In FIGS. 5A and 5B, at least one frame lock element 22 comprises a ring shape. However, in some embodiments, the frame lock element optionally embodies a hook shape. In FIG. 23A to 24B frame lock element 22D embodies a hook shape. It should be noted that the embodiment of the hook shaped frame lock element 22D is equally applicable to all embodiments of the anti-theft device described herein.

What is claimed is:

1. An anti-theft device for an electric bicycle comprises:
(a) an electric battery for powering said electric bicycle;
(b) a dedicated place on a frame of said electric bicycle, configured to accommodate said electric battery;
(c) at least one frame lock structural element, firmly attached to said frame;
(d) at least one battery lock structural element, firmly attached to said electric battery, wherein said at least one battery lock structural element respectively matching said at least one frame lock structural element;
(e) at least one locking element, configured to interlock said at least one frame lock structural element and said at least one battery lock structural element.

2. The anti-theft device, as in claim 1, wherein said at least one lock element is further configured to interlock a rear wheel of said electric bicycle.

3. The anti-theft device, as in claim 1, wherein said dedicated place on said frame further comprises a rail.

4. The anti-theft device, as in claim 3, wherein said at least one battery lock structural element protrudes from a surface of said battery and wherein said rail is distanced from a bridge on said frame by a spacer.

5. The anti-theft device, as in claim 1, wherein said at least one battery lock structural element comprises a protruding structural element extending from a surface of said battery.

6. The anti-theft device, as in claim 1, wherein said at least one battery lock structural element comprises a recessed structural element intruding into a surface of said battery.

7. The anti-theft device, as in claim 1, wherein said at least one frame lock structural element is selected from the group consisting of: a hook, loop, aperture, tab, cylinder and ring.

8. The anti-theft device, as in claim 1, wherein said at least one locking element is selected from the group consisting of: a U-shaped lock, T-shaped bolt, chain, shackle, padlock and any combination thereof.

9. The anti-theft device, as in claim 1, wherein said at least one locking element comprises a shaft movable into at least two different positions.

10. The anti-theft device, as in claim 9, wherein said shaft further comprises a perpendicular pin.

11. A method of securing an electric battery to a frame of electric bicycle, said method comprises:
(a) providing an anti-theft device comprising:
(i) at least one frame lock structural element, firmly attached to said frame;
(ii) at least one battery lock structural element, firmly attached to said electric battery;
wherein said at least one battery lock structural element respectively matching said at least one frame lock structural element;
(b) providing at least one locking element, configured to interlock said at least one frame lock structural element and said at least one battery lock structural element;
(c) disposing said at least one locking element, so as to interlock said at least one frame lock structural element and said at least one battery lock structural element; thereby securing said electric battery to said frame.

12. The method, as in claim 11, wherein said at least one lock element is further configured to interlock a rear wheel of said electric bicycle.

13. The method, as in claim 11, wherein said frame further comprises a rail.

14. The method, as in claim 13, wherein said at least one battery lock structural element protrudes from a surface of said battery and wherein said rail is distanced from a bridge on said frame by a spacer.

15. The method, as in claim 11, wherein said at least one battery lock structural element comprises a protruding structural element extending from a surface of said battery.

16. The method, as in claim 11, wherein said at least one battery lock structural element comprises a recessed structural element intruding into a surface of said battery.

17. The method, as in claim 11, wherein said at least one frame lock structural element is selected from the group consisting of: a hook, loop, aperture, tab, cylinder and ring.

18. The method, as in claim 11, wherein said at least one locking element is selected from the group consisting of: a U-shaped lock, T-shaped bolt, chain, shackle, padlock and any combination thereof.

19. The method, as in claim 111, wherein said at least one locking element comprises a shaft movable into at least two different positions.

20. The method, as in claim 19, wherein said shaft further comprises a perpendicular pin.
